(19) United States
(12) Patent Application Publication
(10) Pub. No.: US 2021/0248206 A1
(43) Pub. Date: Aug. 12, 2021

(54) SYSTEMS AND METHODS FOR GENERATING DATA RETRIEVAL STEPS

(71) Applicant: FLINKS TECHNOLOGY INC., Montreal (CA)

(72) Inventor: Julien DUBE-COUSINEAU, Montreal (CA)

(21) Appl. No.: 17/167,509

(22) Filed: Feb. 4, 2021

Related U.S. Application Data
(60) Provisional application No. 62/975,341, filed on Feb. 12, 2020.
(60) Provisional application No. 63/056,122, filed on Jul. 24, 2020.

(51) Int. Cl. G06F 16/958; G06F 16/954; G06F 16/2452; G06F 16/242; G06N 20/00

(52) U.S. Cl. CPC G06F 16/972; G06F 16/954; G06N 20/00; G06F 16/2423; G06F 16/24524

(57) ABSTRACT

There is disclosed a method and system for generating data retrieval steps for retrieving data. The method comprises receiving an indication of a data source. A page corresponding to the data source is retrieved. A request to indicate a page context of the page is output. Tasks corresponding to the page context are retrieved. The tasks are output. User input corresponding to the tasks is recorded. A set of structured data is generated based on the user input.

### CROSS-REFERENCE TO RELATED APPLICATIONS

This application claims the benefit of U.S. Provisional Patent Application No. 63/056,122, filed Jul. 24, 2020, and U.S. Provisional Patent Application No. 62/975,341, filed Feb. 12, 2020, each of which is incorporated by reference herein in their entirety.

### BACKGROUND

Financial institutions may store user data and provide access to the user data via an application and/or webpage. For example a bank may store a user's account data and transaction history. The user may access the data associated with their account by logging in to their account on the bank's webpage or the bank's application. In some instances the user or another party may wish to retrieve all or a portion of the user's data that is stored by the financial institution.

Some financial institutions allow users to provide access to their data through an interface, such as an application programming interface (API). Another method of retrieving this data is to access the user's account at the financial institution and record the information, such as by logging in to the user's account and then copying the data from web pages output by the bank or from the interface of a bank's application. This method is sometimes referred to as “scraping” the data.

### SUMMARY

A set of retrieval instructions may be used to retrieve a user's data from a financial institution. The retrieval instructions may indicate how to access the data (how to log in to an account, what pages to visit, etc.) and/or which data to record. These instructions may be created manually by a skilled operator, which can be a time consuming an expensive process. Additionally, if the financial institution modifies any element of their web page or application, the retrieval instructions might no longer function until the operator manually updates the retrieval instructions.

Instead of a skilled operator manually coding retrieval instructions, a set of data retrieval steps and/or retrieval instructions may be generated based on an operator's responses to various tasks. An operator may be presented with a series of tasks. For example a login page for a financial institution may be displayed to an operator and the operator may be asked to identify an input area on the login page where a username should be entered.

The input entered by the operator while responding to tasks may be stored as structured data. The stored data may then be used to retrieve a user's data from a financial institution, such as by using the stored data to generate the data retrieval steps. The operator may first be asked to identify a page context of a page that is being displayed. After the operator selects the page context, tasks for that page context may be retrieved. The operator may then be asked to perform the tasks, such as by labeling areas on the page where user input can be entered and/or indicating a function of each of those areas. After completing the tasks for a page context, a next page may be displayed, and the operator may be instructed to select a page context for that next page. Some or all of the tasks may be completed by a machine learning algorithm (MLA) instead of the operator. The responses may be stored as structured data. The responses may be retrieved and then used to retrieve data from the financial institution. After all of the tasks have been completed, data retrieval steps for the financial institution may be generated.

According to a first broad aspect of the present technology, there is provided a method comprising: receiving an indication of a data source; retrieving a page corresponding to the data source, wherein the page corresponds to a first user account for the data source; outputting for display a request to indicate a page context of the page; retrieving a plurality of tasks corresponding to the page context; outputting for display a plurality of requests corresponding to the plurality of tasks; recording user input corresponding to the plurality of tasks; generating, based on the user input and the plurality of tasks, a set of structured data corresponding to the data source; and retrieving, based on the set of structured data, data from the data source, wherein the data corresponds to a second user account for the data source.

In some implementations of the method, the plurality of tasks comprise a request to identify an input area on the page.

In some implementations of the method, the request to identify the input area in the page comprises a request to identify a type of data requested for the input area.

In some implementations of the method, the plurality of tasks comprise a request to identify an area of text on the page.

In some implementations of the method, the user input comprises a location of an area of the page or a location of an object on the page.

In some implementations of the method, the user input comprises an indication of a function of the area of the page or the object on the page.

In some implementations of the method, the set of structured data comprises instructions for: accessing a user's account at the data source; and retrieving the user's account data from the data source.

In some implementations of the method, the request to indicate a page context of the page comprises a request to select a page context of a plurality of page contexts.

In some implementations of the method, the method further comprises: determining that a data retrieval step corresponding to the set of structured data is causing an error; determining a task corresponding to the data retrieval step; outputting for display a request corresponding to the task; recording user input corresponding to the task; and modifying, based on the user input, the set of structured data.

In some implementations a system comprising at least one processor and memory storing a plurality of executable instructions may perform the method.

According to another broad aspect of the present technology, there is provided a method comprising: receiving an indication of a data source; retrieving a page corresponding to the data source, wherein the page corresponds to a first user account for the data source; outputting for display a request to indicate a page context of the page; receiving a selection indicating the page context of the page; retrieving a plurality of tasks corresponding to the page context of the page; determining a first subset of the plurality of tasks to be performed by a human operator; determining a second subset of the plurality of tasks to be performed using a machine learning algorithm (MLA), wherein the MLA was trained using training data comprising a plurality of labeled tasks, and wherein each labeled task of the plurality of labeled tasks comprises an indication of the respective task, user input that was entered in response to the respective task, and page data corresponding to the respective task; outputting for display a plurality of requests corresponding to the first subset of the plurality of tasks; recording user input corresponding to the first subset of the plurality of tasks; causing the MLA to generate responses for each task of the second subset of the plurality of tasks; generating, based on the user input and the responses generated by the MLA, a set of structured data corresponding to the data source; and retrieving, based on the set of structured data, data from the data source, wherein the data corresponds to a second user account for the data source.

In some implementations of the method, the method further comprises, for each task of the plurality of tasks, determining, based on a type of the respective task, a predicted accuracy of the human operator and a predicted accuracy of the MLA; placing tasks having a higher predicted accuracy of the human operator than the predicted accuracy of the MLA in the first subset of the plurality of tasks; and placing tasks having a higher predicted accuracy of the MLA than the predicted accuracy of the human operator in the second subset of the plurality of tasks.

In some implementations of the method, the data source comprises a financial institution.

In some implementations of the method, the set of structured data comprises instructions for retrieving a person's financial data from the financial institution.

In some implementations of the method, the method further comprises inputting, to the MLA, each task of the second subset of the plurality of tasks and page data corresponding to each task.

In some implementations a system comprising at least one processor and memory storing a plurality of executable instructions may perform the method.

According to another broad aspect of the present technology, there is provided a method comprising: receiving a request to retrieve data from a data source; retrieving structured data corresponding to the data source; executing one or more data retrieval steps based on the structured data; determining that an error occurred during execution of a data retrieval step of the data retrieval steps; determining a task corresponding to the data retrieval step; outputting for display an instruction to perform the task; recording user input corresponding to the task; modifying, based on the user input, the set of structured data, thereby generating modified data retrieval steps; and executing the modified data retrieval steps to retrieve the data from the data source.

In some implementations of the method, the method further comprises, receiving credential for accessing the data source.

In some implementations of the method, the task comprises a request to identify an input area on an interface output by the data source.

In some implementations of the method, the data retrieval steps comprise instructions for retrieving an account balance.

In some implementations of the method, the data retrieval steps comprise instructions for retrieving a transaction history.

In some implementations of the method, determining that an error occurred during execution of the data retrieval step comprises receiving data in an incorrect format.

In some implementations a system comprising at least one processor and memory storing a plurality of executable instructions may perform the method.

Various implementations of the present technology provide a non-transitory computer-readable medium storing program instructions for executing one or more methods described herein, the program instructions being executable by a processor of a computer-based system.

Various implementations of the present technology provide a computer-based system, such as, for example, but without being limitative, an electronic device comprising at least one processor and a memory storing program instructions for executing one or more methods described herein, the program instructions being executable by the at least one processor of the electronic device.

In the context of the present specification, unless expressly provided otherwise, a computer system or computing environment may refer, but is not limited to, an “electronic device,” a “computing device,” an “operation system,” a “system,” a “computer-based system,” a “computer system,” a “network system,” a “network device,” a “controller unit,” a “monitoring device,” a “control device,” a “server,” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (e.g., CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

Additional and/or alternative features, aspects and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of an example computing environment in accordance with various embodiments of the present technology;

FIG. 2 is a diagram of a system for retrieving financial data in accordance with various embodiments of the present technology;

FIG. 3 is a diagram of a system for generating data retrieval steps in accordance with various embodiments of the present technology;

FIG. 4 illustrates a flow diagram of a method for retrieving data in accordance with various embodiments of the present technology;

FIG. 5 illustrates a flow diagram of a method for determining data retrieval steps in accordance with various embodiments of the present technology;

FIG. 6 illustrates a flow diagram of a method for performing tasks for a module in accordance with various embodiments of the present technology;

FIG. 7 illustrates a flow diagram of a method for determining wildcard statements in accordance with various embodiments of the present technology;

FIG. 8 illustrates a flow diagram of a method for retrieving financial data in accordance with various embodiments of the present technology;

FIG. 9 illustrates a flow diagram of a method for reviewing responses in accordance with various embodiments of the present technology;

FIG. 10 illustrates a flow diagram of a method for generating a machine learning (ML) model for performing tasks in accordance with various embodiments of the present technology;

FIG. 11 illustrates an example of a financial institution login page in accordance with various embodiments of the present technology; and

FIG. 12 illustrates an example of a financial institution account data page in accordance with various embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that one or more modules may include for example, but without being limitative, computer program logic, computer program instructions, software, stack, firmware, hardware circuitry, or a combination thereof.

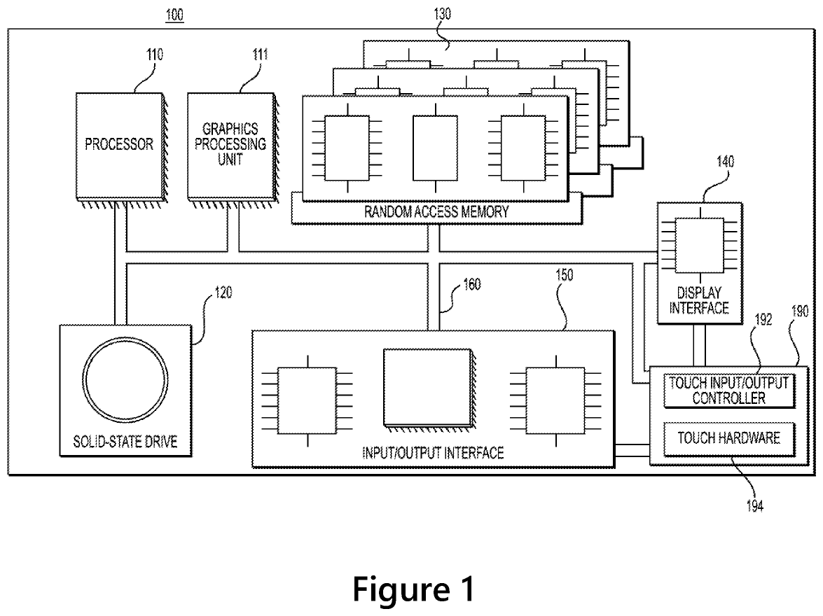

FIG. 1 illustrates a computing environment 100, which may be used to implement and/or execute any of the methods described herein. In some embodiments, the computing environment 100 may be implemented by any of a conventional personal computer, a network device and/or an electronic device (such as, but not limited to, a mobile device, a tablet device, a server, a controller unit, a control device, etc.), and/or any combination thereof appropriate to the relevant task at hand. In some embodiments, the computing environment 100 comprises various hardware components including one or more single or multi-core processors collectively represented by processor 110, a solid-state drive 120, a random access memory 130, and an input/output interface 150. The computing environment 100 may be a computer specifically designed to operate a machine learning algorithm (MLA). The computing environment 100 may be a generic computer system.

In some embodiments, the computing environment 100 may also be a subsystem of one of the above-listed systems. In some other embodiments, the computing environment 100 may be an “off-the-shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units 111 (GPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computing environment 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computing device 100 in addition to or instead of the touchscreen 190.

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or an application.

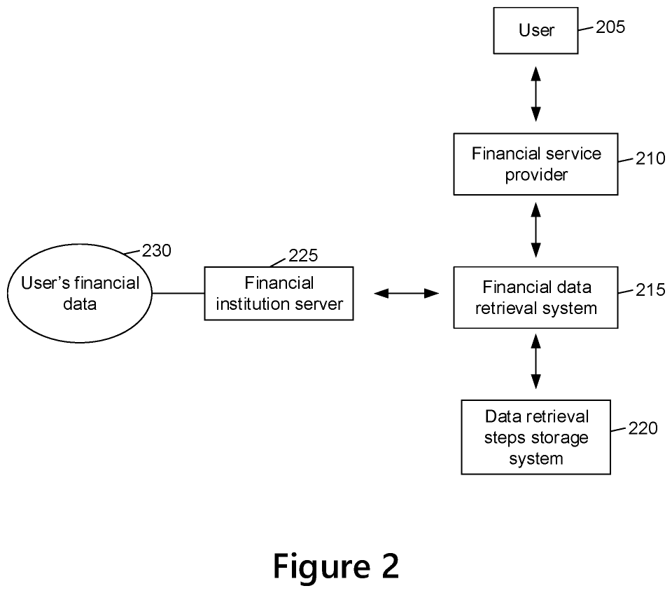

FIG. 2 is a diagram of a system for retrieving financial data in accordance with various embodiments of the present technology. A user 205 may have accounts at various financial institutions. For example the user 205 may have an account at a bank, an account at a brokerage, an account at an insurance company, an account at a loan company, etc. Each of these institutions may store some financial data 230 of the user 205, such as account balances, transaction history, etc. The user 205 may access their financial data 230 by logging in to their account at a financial institution server 225, such as a server controlled by the user's bank. The user 205 may access the financial institution server 225 using a website, application, mobile application, and/or any other suitable interface.

The user 205 may wish to share their financial data 230 with a third party, such as a financial service provider 210. For example if the user 205 were applying for a mortgage, the user 205 may wish to share all or a portion of their financial data 230 with a financial service provider 210 that offers mortgages, such as a mortgage broker.

The financial institution server 225 might not provide an application programming interface (API) for retrieving the user's financial data 230. Instead, a financial data retrieval system 215 may retrieve the user's financial data from the financial institution server 225, such as by scraping the data from web pages output by the financial institution server 225. The financial data retrieval system 215 may receive the user's 205 account information, such as a username, account number, and/or password for accessing the financial institution server 225. The financial data retrieval system 215 may then log in to the financial institution server 225 using the user's 205 credentials. The financial data retrieval system 215 may then retrieve the user's financial data 230, such as by capturing the user's financial data 230 from pages output by the financial institution server 225.

In order to access the user's 205 account at the financial institution server 225 and capture the user's financial data 230, the financial data retrieval system 215 may access stored data retrieval steps. The financial data retrieval system 215 may use the data retrieval steps to retrieve the financial data. The financial data retrieval system 215 may repeat all or a portion of the data retrieval steps. The financial data retrieval system 215 may control a web browser to perform the data retrieval steps. The data retrieval steps may be retrieved from a data retrieval steps storage system 220, which may store data retrieval steps for various different financial institutions. The data retrieval steps may be stored as structured data. The data retrieval steps may include a series of actions to be taken in order to retrieve the user's financial data 230 from the financial institution server 225. The data retrieval steps may indicate how to access an interface of the financial institution, what data should be input, where the data should be input, which data to record, etc.

Although the systems in FIG. 2 are described with regard to retrieving financial data from a financial institution, it should be understood that other types of data may be retrieved, and that this data may be retrieved from other types of institutions. For example if the user 205 were applying for life insurance, the user's 205 health data may be retrieved, or the user's 205 workout data may be retrieved.

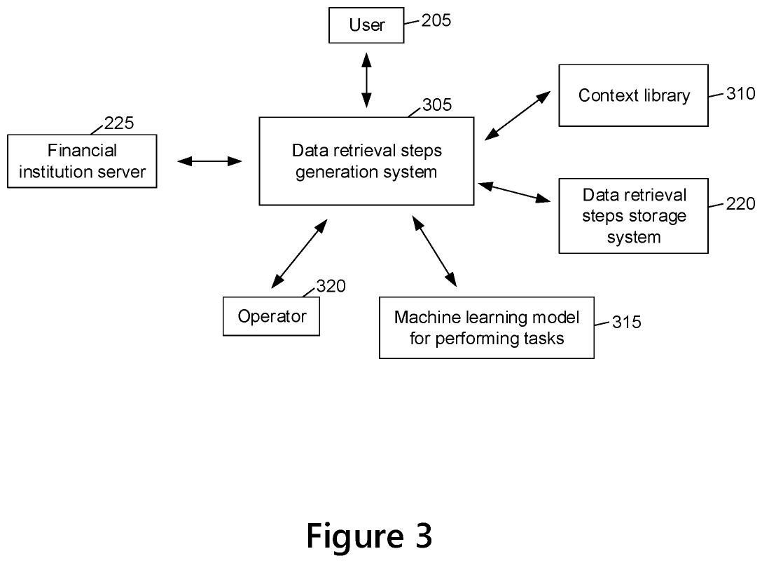

FIG. 3 is a diagram of a system for generating data retrieval steps in accordance with various embodiments of the present technology. A data retrieval steps generation system 305 may generate, cause to be generated, and/or store data indicating actions to be taken for accessing the financial institution server 225 and retrieving financial data from the financial institution server 225. An operator 320 may input an address of the financial institution server 225, such as a uniform resource locator (URL) of the financial institution. A page output by the financial institution server 225, such as a web page or a display of a mobile application may be output to the operator 320.

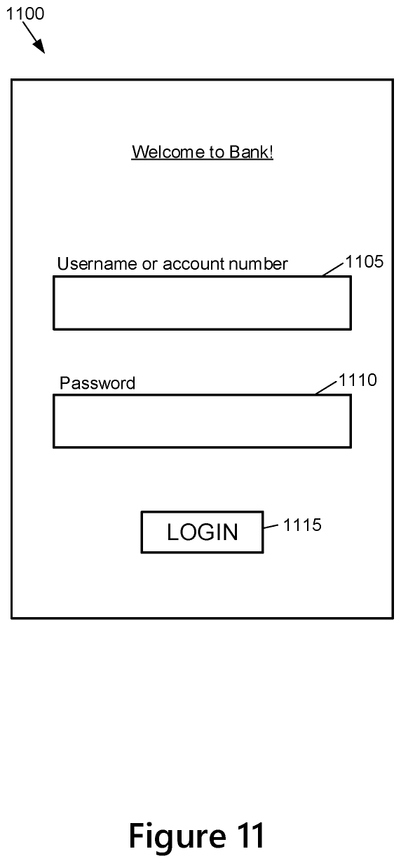

After viewing the page output by the financial institution server 225, the operator 320 may select a page context corresponding to the page. The page context may indicate the type of page displayed. For example if the page is requesting a username and password, the operator 320 may indicate that the page context is a login page. FIG. 11, described in further detail below, illustrates an example of a login page.

After receiving a page context, the data retrieval steps generation system 305 may retrieve tasks corresponding to the page context from the context library 310. The tasks may include various requests, such as requests to identify an area in the page, an input area in the page, a type of data displayed, etc. For example if the page context of a page is account activity, the task may be to identify the transaction history data displayed on the account activity page.

The tasks may be performed by the operator 320 and/or a machine learning algorithm (MLA) 315 for performing tasks. The data retrieval steps generation system 305 may assign the task to the operator 320 and/or the MLA 315. The data retrieval steps generation system 305 may maintain records indicating how accurate the operator 320 is when performing various types of tasks and/or how accurate the MLA 315 is when performing the various types of tasks. The data retrieval steps generation system 305 may determine whether to assign the task to the operator 320 or the MLA 315 by comparing the recorded accuracies for the type of task. If, for that type of task, the MLA 315 has a higher accuracy, the data retrieval steps generation system 305 may assign the task to the MLA 315. Otherwise, the task may be assigned to the operator 320.

In some instances a module may be called based on a response given by the operator. Each module may correspond to a specific type of object and/or data. For example if the operator indicates, in a response to a task, that a page has a date-picker object, a module corresponding to the date-picker object may be called. The module may determine tasks for the operator to complete.

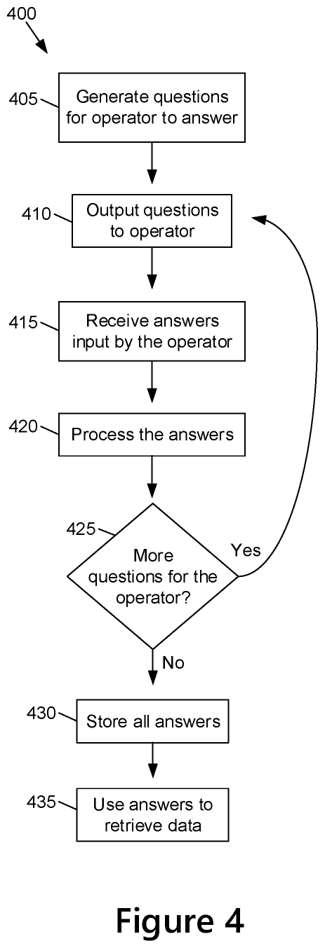

FIG. 4 illustrates a flow diagram of a method 400 for retrieving data in accordance with various embodiments of the present technology. In one or more aspects, the method 400 or one or more steps thereof may be performed by a computing system, such as the computing environment 100. The method 400 or one or more steps thereof may be embodied in computer-executable instructions that are stored in a computer-readable medium, such as a non-transitory mass storage device, loaded into memory and executed by a CPU. The method 400 is exemplary, and it should be understood that some steps or portions of steps in the flow diagram may be omitted and/or changed in order.

At step 410 tasks, which may be in the form of questions, may be generated for an operator to answer. An interface may be presented to the operator, such as a web page or a page of a mobile application. The web page or mobile application may be operated by a financial institution, such as a bank. The tasks may request that the operator identify the type of page being displayed, such as a login page, account overview page, etc. The tasks may request that the operator identify various objects on the page, such as by selecting the account balance, selecting an element that leads to another page, etc. Various other types of tasks and/or any other instructions may be presented to the operator.

At step 415 the operator may enter responses to the tasks. The operator may select an element and/or area on the page, select one of several pre-defined responses to the tasks, type an answer, and/or enter any other type of responses to the tasks.

At step 420 the responses may be processed. Based on the responses, additional tasks may be identified, such as follow-up tasks determined based on the responses. For example if the operator indicates that the page is an account summary page, various tasks corresponding to an account summary page may be retrieved to be presented to the operator.

At step 425 a determination may be made as to whether there are any additional tasks for the operator to perform. The additional tasks may have been determined at step 420. The additional tasks may include additional tasks for the current page, a request to switch to a new page, or additional tasks for a different page. If there are additional tasks, the method 400 may continue at step 410 where the additional tasks may be output to the operator.

If there are no additional tasks, all responses may be stored. The tasks and/or the responses may be stored as structured data. The tasks and/or the responses may be stored in a database.

At step 435 the stored data may be used to retrieve data, such as to retrieve financial data from the financial institution server 225. The stored data may be used to retrieve a user's account data. The operator may answer questions using a first user's account at a financial institution, such as a test account. After storing the answers generated using the test account at step 430, those answers may be used to retrieve data from the financial institution for many other users' accounts at that institution. The answers may be used to automatically retrieve the data without further input from the operator.

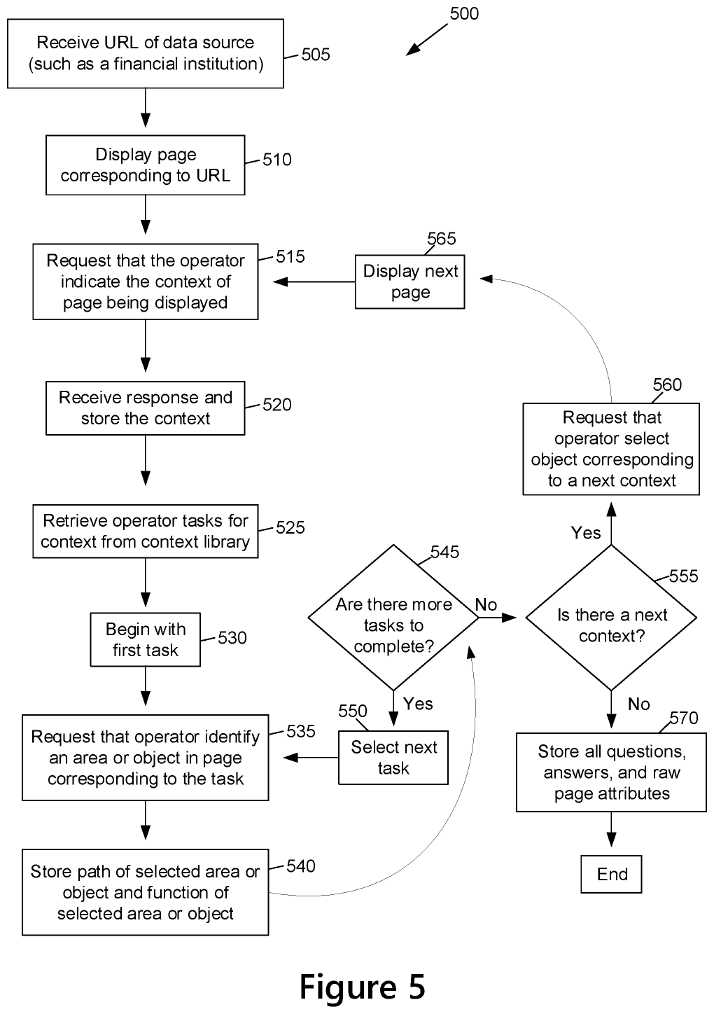

FIG. 5 illustrates a flow diagram of a method 500 for determining data retrieval steps in accordance with various embodiments of the present technology. In one or more aspects, the method 500 or one or more steps thereof may be performed by a computing system, such as the computing environment 100. The method 500 or one or more steps thereof may be embodied in computer-executable instructions that are stored in a computer-readable medium, such as a non-transitory mass storage device, loaded into memory and executed by a CPU. The method 500 is exemplary, and it should be understood that some steps or portions of steps in the flow diagram may be omitted and/or changed in order.

At step 505 a location of a data source may be received. The location may be an interface for accessing the data source. The location may be a webpage, which may be provided by a URL. The URL may be a homepage of a financial institution, such as a bank. The location may be an indication of an application, such as a mobile application. The mobile application may provide access to and/or management of a user's account at the financial institution. Any indication of a data source maintaining a user's financial data may be received at step 505.

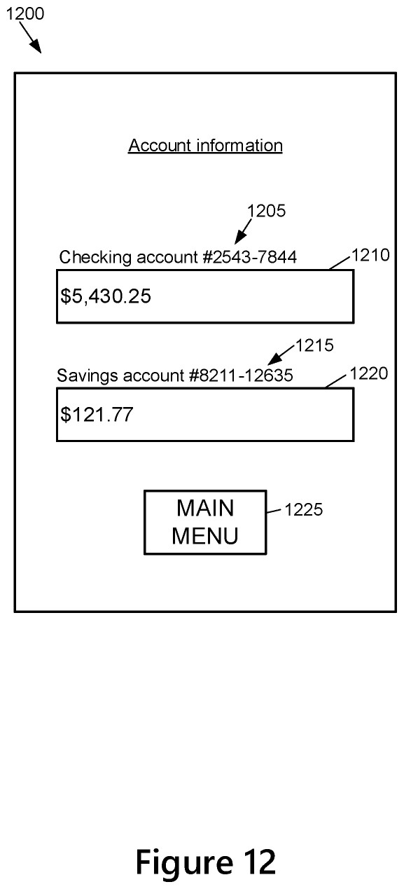

At step 510, a page corresponding to the data source may be displayed. The page may be displayed to an operator 320 of the data retrieval instructions generation system 305. If a URL was received at step 505, the webpage for that URL may be displayed. If the data source is a mobile application, an interface displayed by the mobile application may be displayed at step 510. FIGS. 11 and 12, described in further detail below, are examples of pages that might be displayed at step 510.

At step 515 an operator may indicate the page context of the page being displayed. The operator may select from a list of possible page contexts and/or may type the page context of the page. The operator may select a page context type and then select one or more subtypes of the page context type. The page context may be an indication of the function of the page. For example if the displayed page provides a summary of multiple accounts, the operator may select or otherwise input an “account summary” page context. In another example if the displayed page provides a list of credits and debits from an account, the operator may select or otherwise input a “transaction history” page context.

Various questions may be presented to the operator at step 515 in order to identify the context of the page being displayed. For example a question may be displayed asking the operator to determine whether the page includes an area for entering a username and password, and if the operator selects “yes” then the context may be determined to be a login page. In another example a question may be displayed asking the operator to identify whether the page displays a list of transactions, and if the operator selects “yes” then the context may be determined to be a transaction history page.

At step 520 the selected page context may be received and/or stored. An indicator of the page, such as the URL of the page may be stored and associated with the selected page context. At step 525 operator tasks for the page context may be retrieved from a context library. In some instances multiple tasks may be retrieved. In other instances, a single task may be retrieved, and after the task is completed a next task may be retrieved. The tasks may comprise a series of actions for the operator to complete. A task may include selecting a function of an area of the page, indicating what should be entered in various input areas of the page, indicating a function of links on the page, identifying a type of data displayed on the page, answering a question, etc.

At step 530 a first task may be selected from the tasks received at step 525. The tasks may include an indication of an order for performing the tasks. Multiple tasks may be displayed, and the operator may be instructed to select one of the tasks as the first task. The task may then be performed at step 535, where the operator is instructed to perform the task. An instruction may be displayed requesting that the operator identify an area or object on the page corresponding to the task. An area or object on the page may be highlighted or otherwise indicated and an instruction may be displayed requesting that the operator select the function of the highlighted area or object on the page.

The operator may complete the task, such as by selecting an area or object on the page and/or indicating a function of an area or object on the page. At step 540 the path and/or function of the area or object may be stored. The path may be any indication of the area or object, such as an indication of text displayed on the page and/or coordinates of an input area or selection button on the page. The path may be an indication of a location in the code underlying the page, such as an indication of a location in the hypertext markup language (HTML) comprising the page. Any other data entered by the operator may be saved, such as text, an answer to a question such as a true or false question, etc.

Although the tasks are described as being performed by an operator, an MLA, such as the MLA 315 may be assigned a task in addition to or instead of the operator. The MLA may receive the task and raw page data corresponding to the current page. The MLA may output a solution to the task. For example the MLA may identify a location in the page and/or indicate the function of an element of the page.

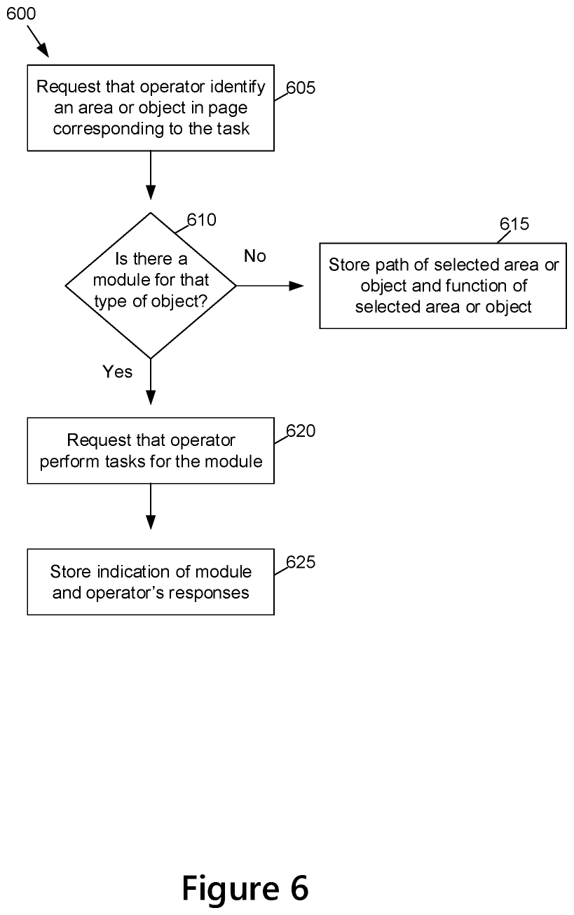

As described in further detail below with regard to FIG. 6, an operator's response to a task may trigger a module. For example if the operator identifies a date-picker in the page, a date-picker module may be triggered. The module may generate additional tasks for the operator.

At step 545 a determination may be made as to whether there are more tasks to complete for the current page context. A determination may be made as to whether there are any elements remaining on the page that have not been labeled. If there are remaining tasks, at step 550 a next task may be selected, and the operator may then complete that task at step 535.

If, at step 545, there are no further tasks for the current page context, at step 555 a determination may be made as to whether there is a next page context. For example if the operator indicated that the current page context is a login page, a determination may be made that there will be additional page contexts after logging in. The results of the tasks performed by the operator may be analyzed to determine whether there are additional page contexts. The responses to the tasks may be analyzed to determine if there is a button or other input area on the page leading to an additional page context.

If there is a next page context, at step 560 a request may be displayed for the operator to select an object corresponding to the next page context. The object may cause a next page to be displayed. In some instances, the object may be selected automatically, and the next page may be displayed without input from the operator. The next page may be displayed at step 565, and then the operator may indicate the page context of the next page at step 515.

If at step 555 there is no additional page context, at step 570 all questions, answers, raw page attributes, and/or other information may be stored. Information relating to the tasks the operator performed and/or questions that the operator responded to may be stored and may be associated with the input entered by the operator in response to the task. For example an indication of each input area in a page may be stored, and each indication may be associated with a label that the operator selected for the respective input area. The data may be stored as structured data. The structured data may be stored in the data retrieval steps storage system 220. The structured data may then be used to retrieve users' financial data from the financial institution.

The raw page attributes for each page may be stored. The raw page attributes may include the code underlying the page, such as HTML, cascading style sheets (CSS), JavaScript, etc. Other information related to the completion of the tasks may be stored as well. For example the amount of time the operator took to complete each task may be stored, information about the order in which the operator completed the tasks may be stored, etc.

Retrieval instructions for the data source may be generated based on the stored data. The retrieval instructions may be generated based on the data stored at step 570. The retrieval instructions might begin with instructions for logging in to a data source. The instructions may indicate that a username should be entered at an input area that the operator has identified corresponds to the username. The instructions may indicate that a password should be entered at an input area that the operator has identified corresponds to the password. The instructions may then indicate how the transaction history of the user can be accessed, and which information on the transaction history pages should be recorded. The retrieval instructions may be stored, such as in the data retrieval steps storage system 220. The retrieval instructions may be stored with an associated URL or other indicator of the data source that the retrieval instructions are configured to access.

The data retrieval system described herein may be “self-healing” in that errors in the data retrieval steps can be detected and corrected rapidly. Rather than manually correcting the stored data by editing the stored data, tasks can be identified based on the error, assigned to an operator, and after the tasks are completed the stored data and/or data retrieval steps can be modified or regenerated based on the results of the tasks. In this manner, any changes to the data source can efficiently be accounted for by modifying the stored data accordingly. The method 900, described below, illustrates how this “self-healing” process may function.

FIG. 6 illustrates a flow diagram of a method 600 for performing tasks for a module in accordance with various embodiments of the present technology. In one or more aspects, the method 600 or one or more steps thereof may be performed by a computing system, such as the computing environment 100. The method 600 or one or more steps thereof may be embodied in computer-executable instructions that are stored in a computer-readable medium, such as a non-transitory mass storage device, loaded into memory and executed by a CPU. The method 600 is exemplary, and it should be understood that some steps or portions of steps in the flow diagram may be omitted and/or changed in order.

At step 605 the operator may be asked to perform a task. The task may be to identify an area or object in a page, to answer a question, and/or perform any other type of task. Actions performed at step 605 may be similar to those performed at step 535 of the method 500, described above.

At step 610 a determination may be made as to whether there is a module corresponding to the input entered by the operator at step 605. The input entered by the operator may trigger one or more modules. Each of the modules may be configured to correspond to a specific type of element, such as a date-picker element, or a transaction history element. A set of modules may be stored, where each module is associated with one or more triggers that causes the module to be called.

If there is not a module corresponding to the response, at step 615 the response data entered by the operator may be stored. The path of a selected area or object and/or the function of the selected area or object may be stored. Any other input entered by the operator may be stored. Actions performed at step 615 may be similar to those performed at step 540 of the method 500, described above. After storing the data, the operator may be asked to perform another task.

If, at step 610, it is determined that there is a module corresponding to the operator's response, the module may be initiated at step 620. One or more tasks may be generated by the module. The operator may be instructed to perform the tasks. The responses to the tasks may be received by the module. Additional tasks may be generated based on the responses.

At step 625 an indication of the module and the operator's responses may be stored. Raw page attributes corresponding to the page may be stored. Any data relating to the operator's responses and/or input from the operator may be stored. The data may be stored as structured data. The data may be retrieved later to repeat some or all of the actions performed by the operator, such as to retrieve a user's financial data. Actions performed at step 625 may be similar to those performed at step 570 of the method 500, described above.

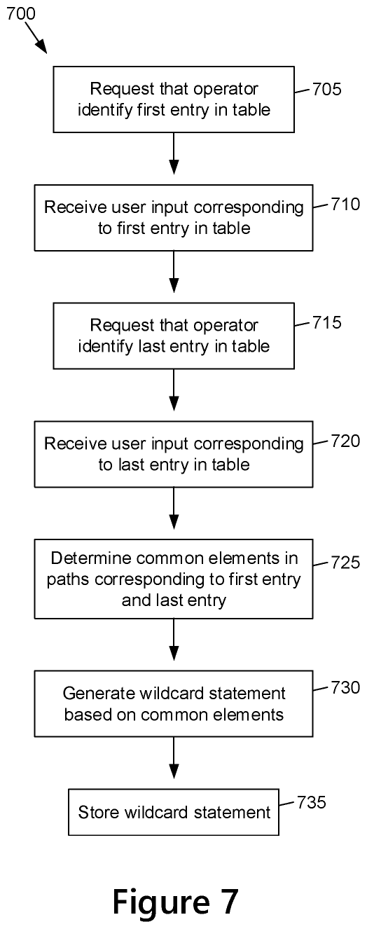

FIG. 7 illustrates a flow diagram of a method 700 for determining wildcard statements in accordance with various embodiments of the present technology. In one or more aspects, the method 700 or one or more steps thereof may be performed by a computing system, such as the computing environment 100. The method 700 or one or more steps thereof may be embodied in computer-executable instructions that are stored in a computer-readable medium, such as a non-transitory mass storage device, loaded into memory and executed by a CPU. The method 700 is exemplary, and it should be understood that some steps or portions of steps in the flow diagram may be omitted and/or changed in order.

A wildcard statement may be used to extract data from a webpage or other interface. In some instances a series of data may be retrieved from a webpage, such as a series of entries in a table, where each entry to be retrieved has a path. For each entry, a portion of the path is common to the other entries to be retrieved and a portion of the path is unique. The wildcard statement may include an expression matching the common portions of the path, and a wildcard indicator corresponding to the portion of the path that is unique. The wildcard statement may then be used to retrieve all of the desired entries in the table.

The wildcard statement may include an absolute expression and a wildcard. The wildcard may be an asterisk, or any other symbol may be used. All data with a path matching the absolute expression may be retrieved, regardless of what is contained in the portion of the path corresponding to the wildcard. An example of a wildcard expression is “(//div[contains(@class, “regular-data-holder toggle-button-summary”)])[1]/table[1]/tbody[1]/tr[*]/td[1]/a[1]”. In this example, the wildcard symbol is an asterisk. A wildcard expression may include any number of wildcard symbols.

The method 700 may be used to generate wildcard statements, by determining portions of paths that are common, and portions that are unique and should be represented with a wildcard symbol. Rather than manually creating a wildcard statement, the method 700 may allow an operator to easily create a wildcard statement by selecting various elements displayed on a webpage.

At step 705 a request may be displayed to an operator to identify a first entry in a table. The request may indicate a type of table or may include any other indicator of the table. For example the request may indicate that the operator should select a first entry in a displayed transaction history.

At step 710 user input may be received identifying the first entry in the table. The operator may highlight the entry, select the entry, or otherwise identify the first entry in the table. A path corresponding to the input may be determined. The path may be a path of the first element in the table. Although steps 705 and 710 refer to the first entry in the table, any entry in the table may be selected by the operator.

At step 715 a request may be displayed to an operator to identify a last entry in the table. Although described as a last entry in the table, any entry other than the entry selected at step 710 may be selected by the operator.

At step 720 user input may be received identifying the last entry in the table. The operator may select the last entry in the same manner used at step 710. A path corresponding to the selected entry may be determined. The path may be the path of the last entry in the table. Although described herein as receiving two entries, a first entry and a last entry, the operator may be asked to identify any number of table entries. For example the operator may be asked to identify a first entry in the table, any middle entry in the table, and a last entry in the table.

At step 725 the path of the first entry and the path of the last entry may be compared. Common elements may be determined for the path of the first entry and the path of the last entry. The portions of the paths that are different may be identified.

At step 730 a wildcard statement may be generated based on the common elements. Each of the common elements of the path may be included in the wildcard statement. Each element of the paths that was different may be replaced with a wildcard operator.

At step 735 the wildcard statement may be stored. The wildcard statement may then be used to retrieve data. For example the wildcard statement may be used at step 435 of the method 400 to retrieve a user's financial data from a financial institution.

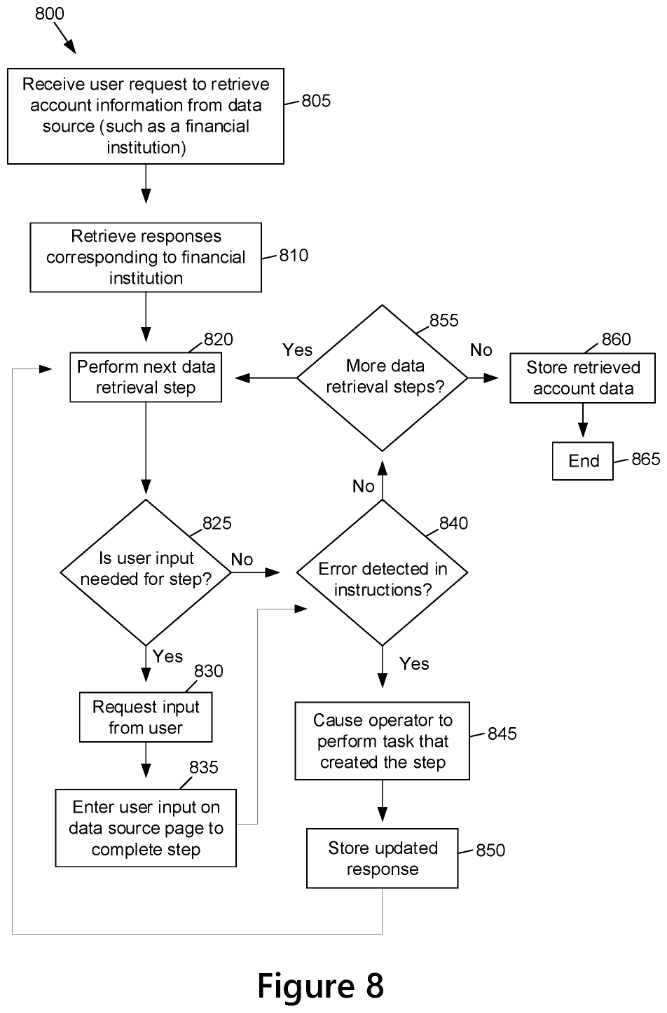

FIG. 8 illustrates a flow diagram of a method 800 for retrieving financial data in accordance with various embodiments of the present technology. In one or more aspects, the method 800 or one or more steps thereof may be performed by a computing system, such as the computing environment 100. The method 800 or one or more steps thereof may be embodied in computer-executable instructions that are stored in a computer-readable medium, such as a non-transitory mass storage device, loaded into memory and executed by a CPU. The method 800 is exemplary, and it should be understood that some steps or portions of steps in the flow diagram may be omitted and/or changed in order.

At step 805 a user request to retrieve financial data from a data source, such as a financial institution, may be received. The user may interact with a financial service provider 210, and the financial service provider 210 may request to retrieve the user's financial data. The user may provide credentials for the data source, such as a username, account number, password, and/or any other data used to access the data source. For example the user may provide their account number and password for accessing their bank.

At step 810 stored data for the financial institution may be retrieved. The stored data may include input entered by operators performing tasks, task data, raw page data, and/or any other data relating to the financial institution may be retrieved. The retrieved data may be structured data. The data may be retrieved from the data retrieval steps storage system 220. The data may have been stored at step 570 of the method 500. Data retrieval instructions for the data source may be retrieved. A URL or other identifier of the data source may be used to select the data to retrieve for accessing the data source.

At step 820 a data retrieval step may be performed. For example the data retrieval step may indicate that a URL should be accessed or that an application should be opened. The data retrieval step may indicate a button to be selected, a selection to be made, data to be captured, an input area to enter input, etc. The data retrieval step may be executed automatically, such as by a web browser plug-in. The data retrieval step may be executed without user input. The data retrieval steps may be executed by an application, such as an application executed by a financial data retrieval system 215.

At step 825 a determination may be made as to whether user input is needed to complete the data retrieval step. If the data retrieval step has been completed at step 820 without user input, the method 800 may proceed to step 840. If, on the other hand, input is needed to complete the data retrieval step, at step 830 the input may be requested from the user.

If the current data retrieval step includes entering data in a form, input may be needed from the user to fill in the form. For example if the data retrieval step involves entering a password in an input area, at step 830 a request to enter the user's password may be displayed to the user. After receiving the user input, at step 835 the data retrieval step may be performed by inputting the user input to the data source page. The user input may be entered into a webpage or other interface of the data source. After entering the user input at step 835, the method 800 may proceed to step 840.

At step 840 a determination may be made as to whether the data retrieval step was executed successfully or whether there was an error. Any abnormal behavior during execution of the data retrieval step may cause an error to be flagged. If the data retrieval step could not be executed, then an error may be flagged. If the data retrieval step executed but returned data that was unexpected, such as in an incorrect format, then an error may be flagged. The data retrieval step or steps causing the error may be indicated in the error. Stored tasks and/or responses corresponding to the error may be determined, such as by identifying the tasks and/or responses that correspond to the data retrieval step. The stored structured data corresponding to the data retrieval step may be identified and/or retrieved.

If an error has been detected, a determination may be made as to which tasks correspond to the data retrieval step or steps causing the error. Tasks may be identified that caused the data retrieval step to be generated. At step 845 an operator may be instructed to perform those tasks that correspond to the data retrieval steps causing the error. For example if the data retrieval step was to select a button corresponding to a function and the button no longer exists on the page (such as if the page was updated), the operator may be tasked with identifying the new location of the button corresponding to the function.

After the operator performs the task or tasks related to the error, at step 850 the data retrieval steps and/or stored data may be updated based on the input entered by the operator. New data retrieval steps may be generated corresponding to the tasks that were completed at step 845 and/or the previous set of data retrieval steps may be modified to incorporate these updated responses. The data retrieval steps that were flagged at step 840 as causing the error may be modified and/or replaced.

After the stored data has been updated at step 850, a next data retrieval step may be performed at step 820. After an error occurs, the execution of the data retrieval steps may begin again at the first data retrieval step of the set of data retrieval steps, essentially restarting the data retrieval process. The execution may continue from where the error occurred, in which case the data retrieval step performed at step 820 may be performed again based on the updated data stored at step 850.

Returning to step 840, if the data retrieval step was executed successfully and no error was detected, the method 800 may proceed from step 840 to step 855. At step 855 a determination may be made as to whether there are additional data retrieval steps to execute in the set of data retrieval steps. If there are any additional data retrieval steps to execute, a next data retrieval step may be performed at step 820. The set of data retrieval steps to be performed may be updated after each data retrieval step is performed. The result of a data retrieval step being performed may cause additional data retrieval steps to be added and/or data retrieval steps to be removed. For example additional data retrieval steps may be added based on the data retrieved from the web page during the execution of a data retrieval step.

If all of the data retrieval steps have been executed at step 855, then any retrieved financial data and/or other data may be stored at step 860. For example if transaction history data was collected during the execution of the data retrieval steps, the transaction history data may be stored. Any other collected data may be stored, such as account status, account numbers, payment instructions, insurance policy information, etc. The data may be stored in a database. The data may be associated with the user and/or the data source. A timestamp may be stored with the data to indicate when the data was retrieved. The data, or metrics generated based on the data, may be transmitted such as to the financial service provider 210. For example an account status and an account balance may be transmitted to the financial service provider 210.

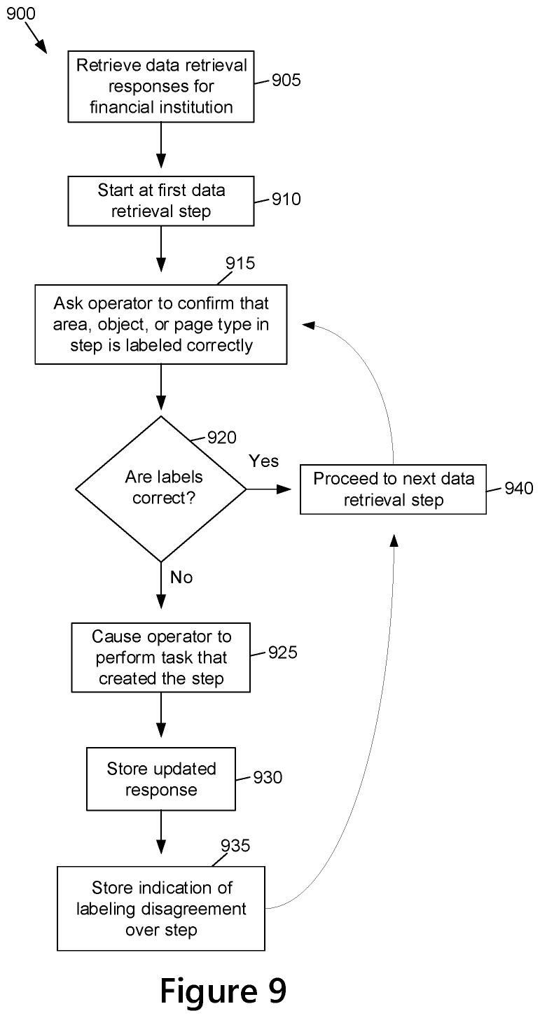

FIG. 9 illustrates a flow diagram of a method 900 for reviewing data retrieval steps in accordance with various embodiments of the present technology. In one or more aspects, the method 900 or one or more steps thereof may be performed by a computing system, such as the computing environment 100. The method 900 or one or more steps thereof may be embodied in computer-executable instructions that are stored in a computer-readable medium, such as a non-transitory mass storage device, loaded into memory and executed by a CPU. The method 900 is exemplary, and it should be understood that some steps or portions of steps in the flow diagram may be omitted and/or changed in order.

To generate data retrieval steps and/or stored responses to tasks that can be used to generate data retrieval steps, such as using the method 500, it may be preferable to use input from multiple operators rather than a single operator. By using input from multiple operators, the accuracy of the stored data may be increased, the number of errors that occur while executing the data retrieval steps may be decreased, and/or the data retrieved using the data retrieval steps may be improved. The method 900 describes a method for confirming data retrieval steps and/or responses to tasks or other input entered by an operator. The data retrieval steps may have previously been generated using input from one or more other operators, and/or the task steps may be previously been completed by one or more other operators.

At step 905 data retrieval steps may be retrieved for a data source. The data retrieval steps may have been generated based on completed tasks, such as tasks completed by operators and/or a machine learning algorithm (MLA). The data retrieval steps may be retrieved, the tasks used to generate the data retrieval steps may be retrieved, and/or the responses to the tasks may be retrieved.

At step 910 a first step of the data retrieval steps may be selected. The selected step may be a portion of structured data corresponding to the financial institution. The selected step may be a task that was completed by an operator. The input entered by the operator when responding to the task may be retrieved. The data retrieval steps may be selected in the order in which they are intended to be executed when retrieving financial data from the financial institution, or in any other order. In some instances, rather than selecting a data retrieval step, a first task may be selected. The tasks may be selected in the order in which they were completed, or in any other order.

At step 915 an operator may be asked to confirm that the data retrieval step is correct. The page or interface corresponding to the data retrieval step may be displayed. The task that caused the data retrieval step to be created and the response to the task may be displayed to the operator, and the operator may be asked to confirm that the response is correct. The operator may be presented the same page that was displayed to a previous operator when that operator was performing a task, the task, and the previous operator's response to the task. The operator may be asked to select whether the previous operator's response is correct or incorrect.

The operator may select an input indicating that the data retrieval step is correct or the operator may select an input indicating that there is an error in the data retrieval step. For example an input area for entering an account number may be highlighted or otherwise indicated on a page, and the operator may be asked to confirm that the highlighted area corresponds to an input area for an account number. The operator may be asked to confirm that each element that was labeled corresponding to the data retrieval step was labeled correctly.

If a task was selected at step 910 rather than a data retrieval step, the operator may be instructed at step 915 to confirm that the response to the task is correct. The operator may be asked at step 915 to confirm a previously generated data retrieval step or a previously entered response to a task and/or the operator may be asked to repeat a task at step 915. If the operator is instructed to repeat the task, the response entered by the operator may be compared to the previous responses to the same task.

At step 920 the user input may be analyzed to determine whether the operator has indicated that the previously stored input was correct. The input may indicate that elements in the page were labeled properly by the previous operator. If the operator indicates that the elements were labeled properly the method 900 may proceed to step 940. At step 940 a next data retrieval step, or next task, may be selected and the operator may then be asked to confirm that the next data retrieval step is correct at step 915.

If, at step 920, the data retrieval step and/or task was indicated by the operator to be incorrect, the method 900 may proceed to step 925. At step 925 the operator may be instructed to perform the task that created the data retrieval step, or otherwise correct the error in the data retrieval step. The operator may be instructed to select an input area, identify an area of text and/or other data, identify a page context, and/or perform any other task. The input entered by the operator may be recorded and/or stored.

At step 930 updated data may be stored, such as in the data retrieval steps storage system 220. The updated data may include the task and/or any input entered by the operator when responding to the task. Based on the input entered at step 925 a modification to the data retrieval step may be determined. The modification may correct the error identified by the operator at step 915. The data retrieval step may be modified to reflect the update. Multiple confirmations may be used to reduce the number of errors in the data retrieval steps, in which case multiple operators may be instructed to confirm that the modification to the data retrieval steps is correct, and the modification may be stored until a threshold number of confirmations have been received.

At step 935 an indication that there was a labeling disagreement may be stored. The indication may be associated with one or more data retrieval steps and/or one or more tasks. The indication may flag the data retrieval steps and/or tasks for further review. An administrator may review the flagged data retrieval steps and/or tasks. Other operators may be instructed to repeat the flagged tasks and/or validate the data retrieval steps. After storing the indication, the method 900 may proceed to step 940 where a next data retrieval step and/or next task may be selected.

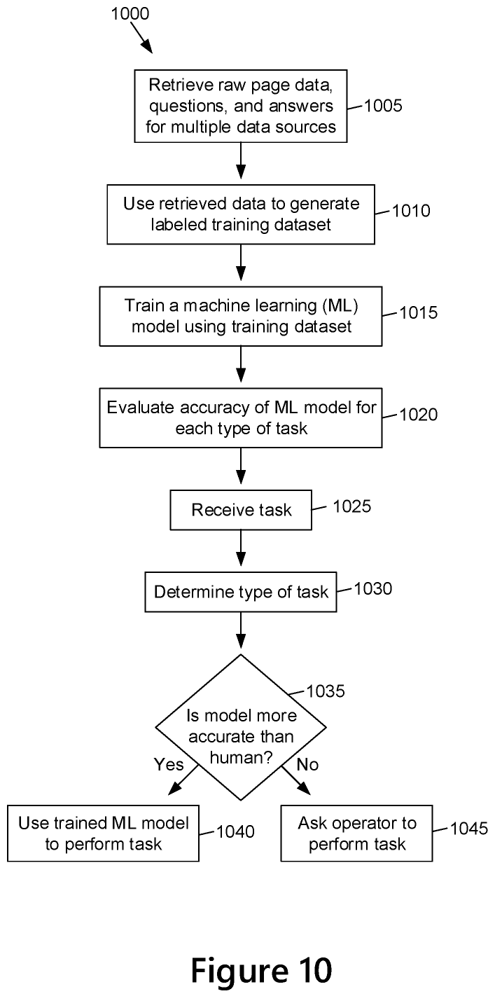

FIG. 10 illustrates a flow diagram of a method for generating an MLA performing tasks in accordance with various embodiments of the present technology. In one or more aspects, the method 1000 or one or more steps thereof may be performed by a computing system, such as the computing environment 100. The method 1000 or one or more steps thereof may be embodied in computer-executable instructions that are stored in a computer-readable medium, such as a non-transitory mass storage device, loaded into memory and executed by a CPU. The method 1000 is exemplary, and it should be understood that some steps or portions of steps in the flow diagram may be omitted and/or changed in order.

The MLA generated using the method 1000, which may be the MLA 315, may receive a task and/or raw page data as input. The MLA may then output a predicted response to the task. The MLA may replace and/or supplement the operator performing tasks. The MLA may be specific to a page context and/or type of task. The accuracy of the MLA and/or the operator may be monitored for each type of task and/or page context. When a task is to be performed, the MLA or the operator may be selected to perform the task based on whether the MLA or the operator has the higher accuracy for that type of task and/or the page context associated with the task.

The MLA may be used to first build a model based on training inputs comprised of data (“training data”) in order to subsequently make data-driven predictions or decisions expressed as outputs, rather than following static computer-readable instructions. MLAs are commonly used for various prediction-like tasks based on some sets of features available as part of input data.

The implementation of the MLAs described herein can be broadly categorized into two phases—a training phase and a prediction phase. During the training phase, a given MLA may receive one or more sets of training data comprising respective training vectors and respective labels. Training vectors are usually indicative of some features that may contain some type of contextual information or that may have some effect on an output, while labels are usually indicative of that output, which is in a sense “desirable” or otherwise of interest. Therefore, labels can be said to represent target results for the given MLA to output for respective training vectors.

Subsequently, during the prediction phase, if a trained MLA receives, as “in-use” input data, a vector “similar” to a given training vector from the training data used in the training phase, the MLA may provide an output “similar” to the label of that training vector. What constitutes “similar” can differ depending on the particular MLA employed.

At step 1005 raw page data, tasks, and/or responses to the tasks may be retrieved. The data may be retrieved for multiple data sources. The data may have been generated by the method 500. The tasks may have been completed by operators, and each response may have been entered by an operator while completing a task. Each response may be associated with one of the tasks. Each of the tasks may be associated with raw page data. The raw page data may comprise code underlying a page, images on the page, and/or any other data corresponding to a page.

The data retrieved at step 1005 may be selected using filters and/or queries. The data retrieved at step 1005 may correspond to a specific page context and/or type of task. The filters and/or queries may be selected based on the type of tasks and/or page contexts the MLA is intended to be used for.

At step 1010 a labeled training dataset may be generated based on the retrieved data. The labeled training dataset may comprise the task and/or raw page data as data points. Each data point may be labeled with the corresponding response to the task. The data may be cleaned and/or filtered, such as by removing incomplete data points, removing outlier data points, removing duplicate data points, and/or applying other preprocessing operations. The data in the labeled training dataset may be converted into and/or stored in a vector format.

At step 1015 an MLA may be trained using the labeled training dataset generated at step 1010. The MLA may be any type of MLA, such as a neural network, tree-based model, etc. In some instances the MLA may comprise multiple MLAs. All or a portion of the labeled training dataset may be input into the MLA. The MLA may be trained to predict the label corresponding to each input training data point. It can be said that the MLA, in a sense, “learns” to correlate the data points in the training to the labels. Put another way, the MLA “learns” that for each training vector, the “desired” value to be outputted is the respective label for that training vector. This is performed so that subsequently, in the prediction phase, the trained MLA would, when provided with an input vector similar to that training vector, generate a given output value similar to the corresponding label.

A loss function may be defined for training the MLA. The loss function may be used to calculate an amount of error between the prediction output by the MLA for an input and the label associated with the input. The MLA may be adjusted to reduce the amount loss output by the loss function. An MLA may be trained to be specific to a type of task and/or a page context. A different MLA may be generated for each type of task and/or each page context.

At step 1020, the accuracy of the MLA for each type of task and/or each page context may be evaluated. If multiple MLAs were generated, such as MLAs specific to a type of task and/or page context, the accuracy of each MLA may be determined. The determined accuracy of each MLA may then be recorded. Over time, the accuracy may be reevaluated and updated, such as if more training data is received for the MLA and/or if any other adjustments are made to the MLA.

Known methodologies may be employed to determine the level of accuracy that a trained MLA might be expected to have when applied to “new” or unseen data. For example, a certain amount of data in the training dataset may be set aside as “test data,” which is labeled data that is not used for training, but rather used to evaluate the performance of the MLA after it has been trained. After training is complete, predictions may be generated (while disregarding the labels) from the values in the training vectors of the test data, and those predictions can then be compared to the labels (representing the “truth”) in order to obtain, for example, a measure of accuracy. This measure of accuracy may be usable as an approximation of the level of accuracy the MLA, can expect to attain if it were to be deployed and applied to new data in the prediction phase to make predictions.

The steps 1025 to 1045 may be performed each time a task is to be performed, such as at step 535 of the method 500. Rather than having an operator submit responses to each of the tasks, it may be more efficient to have the trained MLA perform some or all of the tasks. A determination may be made as to whether the MLA is sufficiently accurate to perform each task.

At step 1025 a task may be received. For example the task may be received at steps 530 or 550 of the method 500. At step 1030 a type and/or page context corresponding to the task may be determined. The type and/or page context may have been received with the task at step 1025.

At step 1035 a determination may be made as to whether the MLA should perform the task or whether an operator should be instructed to perform the task. The accuracy of the MLA when performing this type of task may be compared to the accuracy of the operator when performing this type of task. If the accuracy of the MLA is greater than the accuracy of the operator, or is within a predetermined threshold accuracy of the operator, the MLA may be selected to perform the task at step 1040.

The MLA may output a response to the task and/or an amount of confidence corresponding to the response. If the confidence is below a threshold, such as a pre-determined threshold, the operator may then be instructed to perform the task at step 1045.

If the MLA is not deemed sufficiently accurate at step 1035, the operator may be instructed to perform the task at step 1045. The input of the operator may then be recorded and added to the training dataset for future training of the MLA. Over time, as more input is received from the operators, the accuracy of the MLA may improve.

FIG. 11 illustrates an example of a financial institution login page 1100 in accordance with various embodiments of the present technology. The page 1100 is an example of an interface that may be displayed when visiting a webpage, or an interface that may be displayed in an application, such as a mobile application.

An operator may be instructed to select a page context of the page 1100. The operator may select that the page context of the page 1100 is a login page. An MLA may be instructed to predict the page context of the page 1100. The MLA may receive raw page data for the page 1100 and/or text or images displayed on the page 1100 as input.

After the page context is selected or predicted, tasks corresponding to the page context may be retrieved. The tasks may include identifying a username input area, identifying a password input area, and/or identifying a button for advancing to a next page context. In response to a task requesting that a username input area be identified, an operator may select the input area 805.

Various areas on the page may be highlighted or otherwise indicated, and the operator may be requested to identify a function of the highlighted area. The tasks may include identifying the function of the input area 1105, identifying the function of the input area 1110, and identifying the function of the button 1115. For example if the area 1110 is highlighted, the operator may input that the area 1110 corresponds to a password input area.

A trained MLA, such as an MLA generated using the method 1000, may be used to predict responses to the tasks. The MLA may receive raw page data for the page 1100 and/or text or images displayed on the page 1100 as input. The MLA may also receive the tasks and, for each task, output a predicted response to the task.

FIG. 12 illustrates an example of a financial institution account data page 1200 in accordance with various embodiments of the present technology. The page 1200 is an example of an interface that may be displayed when visiting a webpage or an interface that may be displayed in an application, such as a mobile application.

An operator may be instructed to select a page context of the page 1200. The operator may select that the page context of the page 1200 is an account overview page. An MLA may be instructed to predict the page context of the page 1200. The MLA may receive raw page data for the page 1200 and/or text or images displayed on the page 1200 as input. The MLA may output a context of the page 1200.

After the page context is selected or predicted, tasks corresponding to the page context may be retrieved. The tasks may include identifying an account type, identifying an account balance, identifying an account number, and/or identifying a button for advancing to a next page context. For example an operator may be instructed to identify an account number and type, the operator may select the text 1205, select that the account type is a checking account, and input that the account number is “2543-7844.”

Various areas on the page may be highlighted or otherwise indicated, and the operator may be requested to identify a function of the highlighted area. The tasks may include identifying the type of data displayed on the label 1205, identifying the function of the input area 1210, identifying the type of data displayed on the label 1215, identifying the function of the input area 1220, and/or identifying the function of the button 1225. For example if the label 1215 is highlighted, the operator may indicate that the label 1215 corresponds to an indication of a type of account and an account number.

A trained MLA, such as an MLA generated using the method 1000, may be used to predict responses to the tasks. The MLA may receive raw page data for the page 1200 and/or text or images displayed on the page 1200 as input. The MLA may also receive the tasks and, for each task, output a predicted response to the task.

While some of the above-described implementations may have been described and shown with reference to particular acts performed in a particular order, it will be understood that these acts may be combined, sub-divided, or re-ordered without departing from the teachings of the present technology. At least some of the acts may be executed in parallel or in series. Accordingly, the order and grouping of the act is not a limitation of the present technology.

It should be expressly understood that not all technical effects mentioned herein need be enjoyed in each and every embodiment of the present technology.

As used herein, the wording “and/or” is intended to represent an inclusive-or; for example, “X and/or Y” is intended to mean X or Y or both. As a further example, “X, Y, and/or Z” is intended to mean X or Y or Z or any combination thereof.

The foregoing description is intended to be exemplary rather than limiting. Modifications and improvements to the above-described implementations of the present technology may be apparent to those skilled in the art.

1. A method comprising:
receiving an indication of a data source;
retrieving a page corresponding to the data source, wherein the page corresponds to a first user account for the data source;
outputting for display a request to indicate a page context of the page;
retrieving a plurality of tasks corresponding to the page context;
outputting for display a plurality of requests corresponding to the plurality of tasks;
recording user input corresponding to the plurality of tasks;
generating, based on the user input and the plurality of tasks, a set of structured data corresponding to the data source; and
retrieving, based on the set of structured data, data from the data source, wherein the data corresponds to a second user account for the data source.

2. The method of claim 1, wherein the plurality of tasks comprise a request to identify an input area on the page.

3. The method of claim 2, wherein the request to identify the input area in the page comprises a request to identify a type of data requested for the input area.

4. The method of claim 1, wherein the plurality of tasks comprise a request to identify an area of text on the page.

5. The method of claim 1, wherein the user input comprises a location of an area of the page or a location of an object on the page.

6. The method of claim 5, wherein the user input comprises an indication of a function of the area of the page or the object on the page.

7. The method of claim 1, wherein the set of structured data comprises instructions for:
accessing a user's account at the data source; and
retrieving the user's account data from the data source.

8. The method of claim 1, wherein the request to indicate a page context of the page comprises a request to select a page context of a plurality of page contexts.

9. The method of claim 1, further comprising:
determining that a data retrieval step corresponding to the set of structured data is causing an error;
determining a task corresponding to the data retrieval step;
outputting for display a request corresponding to the task;
recording user input corresponding to the task; and
modifying, based on the user input, the set of structured data.

10. A method comprising:
receiving an indication of a data source;
retrieving a page corresponding to the data source, wherein the page corresponds to a first user account for the data source;
outputting for display a request to indicate a page context of the page;
receiving a selection indicating the page context of the page;
retrieving a plurality of tasks corresponding to the page context of the page;
determining a first subset of the plurality of tasks to be performed by a human operator;
determining a second subset of the plurality of tasks to be performed using a machine learning algorithm (MLA), wherein the MLA was trained using training data comprising a plurality of labeled tasks, and wherein each labeled task of the plurality of labeled tasks comprises an indication of the respective task, user input that was entered in response to the respective task, and page data corresponding to the respective task;
outputting for display a plurality of requests corresponding to the first subset of the plurality of tasks;
recording user input corresponding to the first subset of the plurality of tasks;
causing the MLA to generate responses for each task of the second subset of the plurality of tasks;
generating, based on the user input and the responses generated by the MLA, a set of structured data corresponding to the data source; and
retrieving, based on the set of structured data, data from the data source, wherein the data corresponds to a second user account for the data source.

11. The method of claim 10, further comprising:
for each task of the plurality of tasks, determining, based on a type of the respective task, a predicted accuracy of the human operator and a predicted accuracy of the MLA;
placing tasks having a higher predicted accuracy of the human operator than the predicted accuracy of the MLA in the first subset of the plurality of tasks; and
placing tasks having a higher predicted accuracy of the MLA than the predicted accuracy of the human operator in the second subset of the plurality of tasks.

12. The method of claim 10, wherein the data source comprises a financial institution.

13. The method of claim 12, wherein the set of structured data comprises instructions for retrieving a person's financial data from the financial institution.

14. The method of claim 10, further comprising inputting, to the MLA, each task of the second subset of the plurality of tasks and page data corresponding to each task.

15. A method comprising:
receiving a request to retrieve data from a data source;
retrieving structured data corresponding to the data source;
executing one or more data retrieval steps based on the structured data;
determining that an error occurred during execution of a data retrieval step of the data retrieval steps;
determining a task corresponding to the data retrieval step;
outputting for display an instruction to perform the task;
recording user input corresponding to the task;
modifying, based on the user input, the set of structured data, thereby generating modified data retrieval steps; and
executing the modified data retrieval steps to retrieve the data from the data source.

16. The method of claim 15, further comprising receiving credentials for accessing the data source.

17. The method of claim 15, wherein the task comprises a request to identify an input area on an interface output by the data source.

18. The method of claim 15, wherein the data retrieval steps comprise instructions for retrieving an account balance.

19. The method of claim 15, wherein the data retrieval steps comprise instructions for retrieving a transaction history.

20. The method of claim 15, wherein determining that an error occurred during execution of the data retrieval step comprises receiving data in an incorrect format.
